(19) United States
(12) Patent Application Publication
(10) Pub. No.: US 2007/0006705 A1
(43) Pub. Date: Jan. 11, 2007

(54) PUNCHING DEVICE

(76) Inventor: Wan Young OH, Seoul (KR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/423,512

(22) Filed: Jun. 12, 2006

(30) Foreign Application Priority Data
Jun. 15, 2005 (KR) 10-2005-0051484

(51) Int. Cl. B26D 5/08

(52) U.S. Cl. 83/619; 83/588; 83/821

(57) ABSTRACT

There is a punching device comprising a body and a base separated from the body for accurately forming a desired pattern at a position required by a user. The body includes a jig on which a predetermined shape of pattern hole is formed, a punching member having a punching pin provided with a cutting blade corresponding to the predetermined shape of the pattern hole, and for punching a desired position of a sheet member while moving up and down with respect to the jig, and a resilient member interposed between the punching member and the jig for recovering the punching member, wherein at least two magnets are inserted into the jig. Through this construction, it is possible to simply and accurately align the pattern on the same line by attraction and repulsion of a plurality of magnets inserted into the jig and a guide plate, on which a pattern hole and a guide hole are formed in the same shape, respectively. As a result, the punching device of the present invention can readily punch a desired pattern at all positions required by a user, including a center portion as well as a periphery portion of the sheet member.

### FIELD OF THE INVENTION

The present invention generally relates to a punching device, and more particularly, to a punching device capable of readily punching a desired pattern at all positions required by a user, including a center portion as well as a periphery portion of a sheet member, by simply and accurately aligning the pattern on the same line as holes, using such a structure that includes a body and a base, which are fully separated from each other and have a plurality of magnets, namely, by attraction and repulsion of the plurality of magnets inserted into a jig and a guide plate, on which a pattern hole and a guide hole having the same shape as the pattern hole are formed, respectively.

### BACKGROUND OF THE INVENTION

Referring to FIG. 1, a conventional punching device includes a jig 10 on which a unique pattern of through-hole 10a is formed, a base 20 for supporting the jig 10 at its lower part, and a cutting member 30 having a sharp blade sliding through the through-hole 10a of the jig 10. Through such a structure, a specific portion of a sheet member 1 can be punched in the same pattern as the through-hole 10a of the jig 10.

In this punching device, it is inevitably required to prepare a gap at the jig 10 in order to insert the sheet member. Specifically the jig 10 should be configured in such a way that its cross-section has a substantially [symbol] shaped structure to form the gap.

However, the conventional punching device has a drawback that it can punch only a periphery portion of the sheet member, rather than all portions including a center portion desired by a user.

### SUMMARY OF THE INVENTION

Therefore, a primary object of the present invention is to provide a punching device capable of readily punching a desired pattern at all positions required by a user, including a center portion as well as a periphery portion of a sheet member, by simply and accurately aligning the pattern on the same line as holes, using such a structure that includes a body and a base, which are fully separated from each other and have a plurality of magnets, i.e., by attraction and repulsion of the plurality of magnets inserted into a jig and a guide plate, on which a pattern hole and a guide hole having the same shape as the pattern hole are formed, respectively.

Another object of the present invention is to provide a punching device which allows children to more stably use the punching device by extending a button member and a housing, i.e., by forming a body more lengthily, to function as a handle.

Still another object of the present invention is to provide a punching device with excellent cutting and coating properties by forming each of a jig, a punching member and a support member of a zinc material.

Yet still another object of the present invention is to provide a punching device in which a plane part of a punching member is contacted with a jig as close as possible using a spiral spring as a resilient member, to thereby decrease an amount of zinc consuming by minimizing a length of a punching pin of zinc material and also improve productivity by alleviating a weight of the punching device itself.

Further still another object of the present invention is to provide a punching device capable of preventing a sheet member from being wrinkled by making a base support the sheet member during punching wherein a size of the base is larger than that of a body.

Further yet another object of the present invention is to provide a punching device capable of accurately supplying a sheet member to a position at which a user wants to punch by forming horizontal and vertical guide lines on a surface of a support member.

Still yet another object of the present invention is to provide a punching device capable of repeatedly punching a desired pattern at a position spaced apart by a certain distance from a center at predetermined intervals while rotating a sheet member and also preventing movement of the sheet member during a user's punching work, by installing a center pin at a predetermined position of a surface of a support member.

To accomplish the above objects of the present invention, there is provided a punching device comprising a body and a base separated from the body for accurately forming a desired pattern at a position required by a user, the body comprising: a jig on which a predetermined shape of pattern hole is formed; a punching member having a punching pin provided with a cutting blade corresponding to the predetermined shape of the pattern hole, and for punching a desired position of a sheet member while moving up and down with respect to the jig; and a resilient member interposed between the punching member and the jig for recovering the punching member, wherein at least two magnets are inserted into the jig.

The base includes a guide plate on which the same shape of guide hole as the pattern hole of the jig is formed; and a support member for fixing the guide plate and providing a supply surface to which the sheet member to be punched is supplied, wherein at least two magnets are inserted into the guide plate.

The magnets inserted into the jig and the magnets inserted into the guide plate are arranged in such a way that S and N poles are appropriately combined on the basis of the pattern hole and the guide hole.

The magnets are arranged in such a manner that the three magnets are disposed at intervals of 120°.

Each of the punching member, the jig, or the guide plate is formed of a zinc material.

The body further includes a button member, as a contact portion, disposed on the punching member to be pushed by a user's hand; and a housing enclosing the button member, the punching member, and the resilient member.

The base is configured to be larger than the body to prevent the sheet member from being crumpled during punching.

The base is provided with horizontal and vertical guide lines formed on a surface of a support member to accurately supply the sheet member to a position at which the user wants to punch.

The base further includes a center pin.

The resilient member is a spiral spring.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF DRAWINGS

The above and other objects and features of the instant invention will become apparent from the following description of preferred embodiments taken in conjunction with the accompanying drawings, in which:

FIG. 1 shows a schematic cross-sectional view of a conventional punching device;

FIG. 2 is a perspective view showing an appearance of a punching device in accordance with an embodiment of the present invention;

FIG. 3 is a perspective view showing an appearance of a punching device in accordance with another embodiment of the present invention;

FIG. 4a is an exploded perspective view exemplifying a configuration of a body of the punching device shown in FIG. 2;

FIG. 4b is an exploded perspective view illustrating a configuration of a support member of the punching device shown in FIG. 2;

FIG. 5 exemplifies a perspective view of a base in accordance with another embodiment of the present invention;

FIGS. 6a to 6e are views showing some cases when the punching device in accordance with an embodiment of the present invention is used; and

FIG. 7 is a plan view showing a state when the punching device of FIG. 6c is utilized.

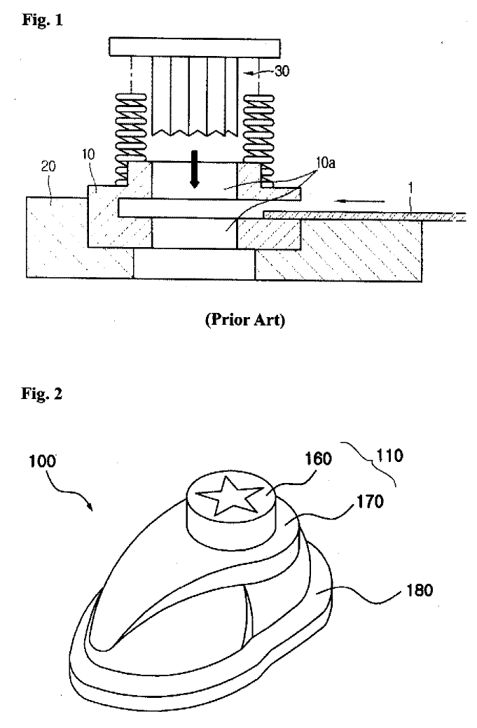

### DETAILED DESCRIPTION OF THE PRESENT INVENTION

Hereinafter, a punching device in accordance with the present invention will be described in detail with reference to the accompanying drawings.

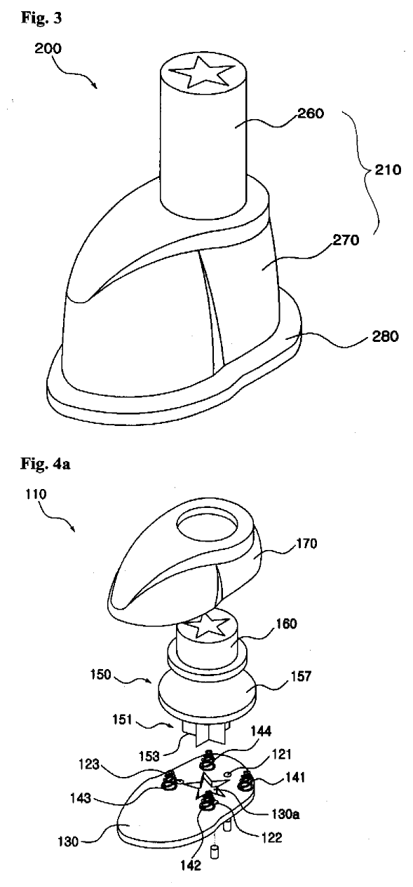

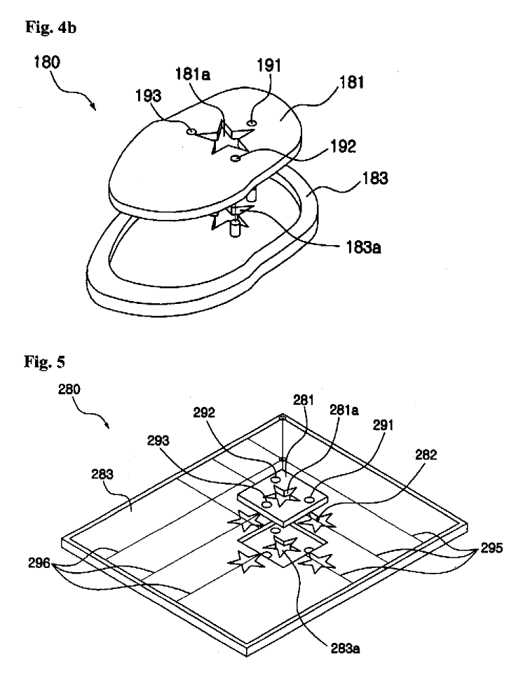

FIG. 2 is a perspective view showing an appearance of a punching device in accordance with an embodiment of the present invention, FIG. 3 is a perspective view showing an appearance of a punching device in accordance with another embodiment of the present invention, FIG. 4a is an exploded perspective view illustrating a configuration of a body of the punching device shown in FIG. 2, FIG. 4b is an exploded perspective view exemplifying a configuration of a support member of the punching device shown in FIG. 2, and FIG. 5 is a perspective view of a base in accordance with another embodiment of the present invention.

Referring to FIGS. 2 to 5, the present invention provides a punching device 100 which is capable of accurately forming a pattern at a position desired by a user, and generally includes a body 110 and a base 180 filly separated from the body 110.

In addition, as shown in FIG. 3, it is preferable to extend a body 210 namely, to form a button member 260 and a housing 270 more lengthily to function as a handle, thus allowing children to more stably use the punching device 200 of the present invention. Further, the button member, the housing, and the base may be designed in various shapes that a user can readily grip and use them, without any limitation.

Referring to FIG. 4a, the body 110 includes a jig 130 on which a predetermined shape of pattern hole 130a is formed, a punching member 150 having a punching pin 151 provided with a cutting blade 153 corresponding to the shape of pattern hole 130a and for punching a desired position of a supplied sheet member while moving up and down with respect to the jig 130, and resilient members 141, 142, 143 and 144 interposed between the punching member 150 and the jig 130 to recover the punching member. The jig 130 has at least two magnets 121,122 and 123 inserted thereinto.

Preferably, the body 110 further includes a button member 160, as a contact portion, installed on the punching member 150 to be pushed by a user's hand, and a housing 170 covering the button member 160, the punching member 150, and the resilient members 141, 142, 143 and 144.

The button member 160 is installed on the punching member 150 and serves to push the punching member 150 downwardly when a user pushes the button member 160.

At this time, the button member 160 is covered with the housing 170 having an upper open structure and engaged with the base 180, so that an upper part of the button member 160 is partially exposed to outside. In addition, the housing 170 supports a flange on the button member 160, thereby preventing separation of the button member 160 by a resilient force 6f the resilient members applied to the punching member 150. In this configuration, the housing 170 surrounds the button member 160, and the punching member 150 and the resilient members 141, 142, 143 and 144 below the button member 160 as a whole.

Further, the punching member 150 is configured to move up and down with respect to the jig 130, wherein the cutting blade 153 of the punching member 150 punches the sheet member while passing through the pattern hole 130a. And also, the resilient members 141, 142, 143 and 144 are interposed between the punching member 150 and the jig 130 to resiliently bias the punching member 150 upwardly in order to selectively descend the punching member 150 towards the jig 130.

At this time, it is preferable that the jig 130 and the punching member 150 are formed of a zinc material, in consideration of cutting and coating properties, insertion of magnets to be described hereinafter (first magnets 121, 122 and 123, and second magnets 191, 192 and 193), etc.

In the above-described construction, while the punching member 150 moves up and down according to a user's manipulation, the punching pin 151 having the cutting blade 153 at its end selectively passes through the pattern hole 130a of the jig 130, thus punching a desired pattern at the supplied sheet member.

As the resilient members 141, 142, 143 and 144, there may be used various kinds of resilient bodies; but it is preferable that plate or spiral springs are utilized for the purpose. During the punching work, it is also preferable that the punching member 150 is lowered to compress the resilient members 141, 142, 143 and 144 to thereby allow a plane part 157 of the punching member 150 to be contacted with the jig 130 as close as possible in consideration of the length of compressed springs. Accordingly, an amount of zinc consuming can be decreased by minimizing a length of the punching pin 151 formed of zinc material and in turn productivity can be improved by alleviating a weight of the punching device 100 itself. For the above purpose, it is particularly preferable to use the spiral springs of all things,

In other words, in case of using the plate spring, since the spring itself has a certain length even after compression, the punching pin 151 should be unnecessarily extended by the length of the spring itself, excluding a minimum length required to pass through the pattern hole 130a of the jig 130 and the guide hole 181a of the guide plate 181.

In addition, a single spring may be configured to surround the predetermined shape of punching pin 151 and also more than two springs may be appropriately disposed on the basis of the punching pin 151. For example, if the punching pin 151 is composed of a plurality of patterns or a plurality of punching pins constitutes an assembly, it is preferably that more than two springs are appropriately disposed to uniformly maintain a recovering force of the resilient members 141, 142, 143 and 144 at a constant magnitude (see FIG. 4a).

Turning to FIG. 4b, the base 180 includes a guide plate 181 on which a guide hole 181a having the same shape as the pattern hole 130a is formed, and a support member 183 to which the guide plate 181 is fixed and for providing a supply surface to supply the sheet member to be punched. The guide plate 181 has at least two second magnets 191, 192 and 193 inserted thereinto.

At this time, the support member 183 may be provided with a through-hole 183a for getting rid of the cut sheet member, wherein the through-hole 183a may have the same shape as the pattern hole 130a and the guide hole 181a.

It is preferable that the support member 183 is formed of a zinc material based on cutting and coating properties, insertion of magnets (the first magnets 121, 122 and 123, and the second magnets 191, 192 and 193) to be described hereinafter, and so on.

Further, referring to FIGS. 4a and 4b, at least two magnets (the first magnets 121, 122 and 123, and the second magnets 191, 192 and 193) are inserted into the jig 130 and the guide plate 181, respectively, so that S and N poles form an appropriate combination on the basis of the shapes of the through-hole 183a and the guide hole 181a. Therefore, although the body 110 and the base 180 are spaced apart from each other by a certain distance, they can be engaged with each other by fitting the shape of the pattern hole into that of the through-hole by attraction (121 and 191, 122 and 192, and 123 and 193) and repulsion (121 and 122, 191 and 192, 121 and 193, 122 and 193, 123 and 191, and 123 and 192) of the magnets (the first magnets 121, 122 and 123, and the second magnets 191, 192 and 193). The body 110 and the base 180 are operated in the same manner even after the sheet member is supplied onto the supply surface of the support member 183.

At this time, it is preferable that the respective three magnets (the first magnets 121, 122 and 123, and the second magnets 191, 192 and 193) are disposed on the jig 130 and the support member 183 at intervals of 120°, that is, N and S poles are disposed in an array of NNS or SSN thereon. For example, if the first magnets 121, 122 and 123 of three are inserted into the jig 130 in an array of NNS at intervals of 120°, the second magnets 191, 192 and 193 of three are inserted into the guide plate 181 in which an array of SSN is disposed at positions corresponding to the first magnets 121, 122 and 123. By doing so, the body 110 and the base 180 can be engaged with each other by fitting the shape of the pattern hole into that of the through-hole by the attraction and the repulsion of the six magnets (the first magnets 121, 122 and 123, and the second magnets 191, 192 and 193).

In this arrangement, it is preferable that the magnets (the first magnets 121, 122 and 123, and the second magnets 191, 192 and 193) have about 4500 to 5500 Gauss of magnetic force to prevent the phenomenon that the body 110 and the base 180 do not adhere to each other due to too weak attraction or they are previously adhered to each other owing to too strong attraction although the pattern hole 130a of the jig 130 is not accurately aligned to the guide hole 181a of the guide plate 181.

Specifically, in the punching device 100 of the present invention, when the sheet member to be punched is supplied on the support member 183 and the body 110 is closed to the base 180 within a certain distance, attraction and repulsion interact between three pairs of magnets (the first magnets 121, 122 and 123, and the second magnets 191, 192 and 193) although the user cannot visually recognize the location of the guide hole 183a formed on the support member 183. Thus, the punching patterns equally formed on the body 10 and the base 180 can be readily and accurately aligned to each other with the sheet member therebetween.

As described above, the punching device 100 of the present invention is configured to have the body 110 and the base 180 fully separated from each other, thus readily punching a desired pattern at all positions required by a user including a periphery as well as a center of the sheet member supplied, differently from the prior art that punching is allowed on only specific portions of the sheet member such as upper and lower ends, corners, or the like.

Referring to FIGS. 2 to 5, it is preferable that a size of the base 180 is larger than that of the body 110. This is because the first magnets 121, 122 and 123 can be easily separated from the second magnets 191, 192 and 193 when the body 110 and the base 480 are separated from each other for the user to complete the punching work or perform the next punching work.

In addition, if the base 180 is larger than the body 110, the base 180 can support the sheet member, thereby preventing the sheet member S from being wrinkled during the punching work of the user.

It is more preferable that horizontal guide lines 295 and vertical guide lines 296 are formed on the surface of the support member 283 (see FIG. 5). These horizontal and vertical guide lines 295 and 296 serve to help supply the sheet member S to an accurate position at which the user wants to punch.

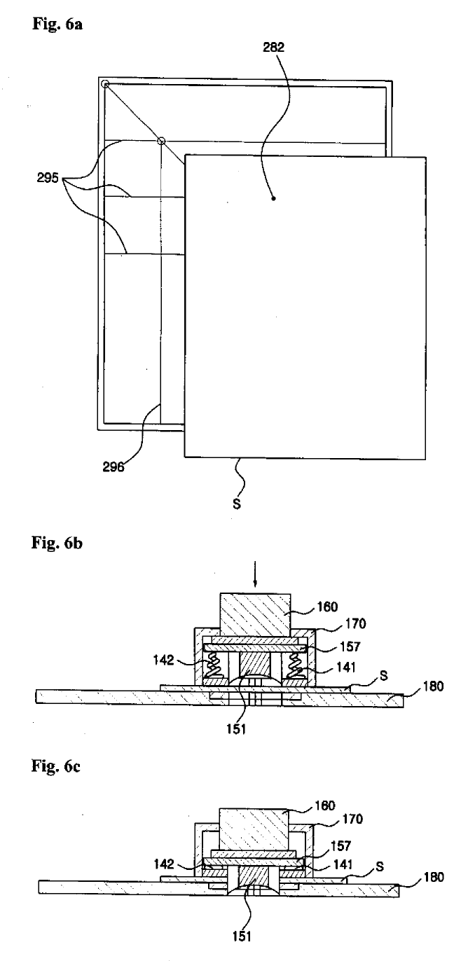

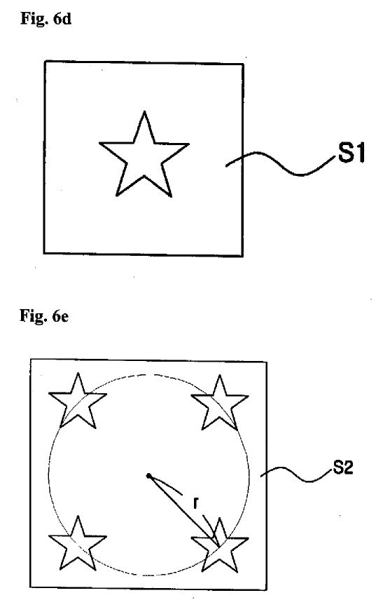

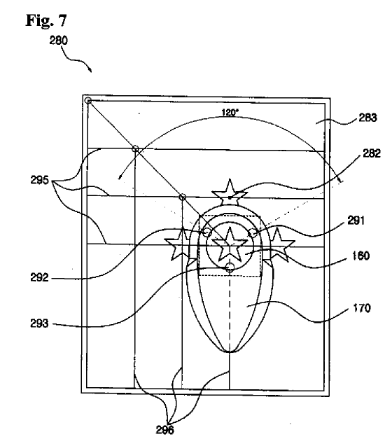

Further, it is preferable that a center pin 282 is installed at a predetermined position of the surface of the support member 183 to repeatedly punch the desired pattern at a position spaced apart by a certain distance r from a center thereof at predetermined intervals while rotating the sheet member S (see FIG. 6e). In addition, the center pin 282 also functions to play the role of preventing movement of the sheet member S during the punching work of the user.

FIG. 6a is a cross-sectional view of the punching device in accordance with an embodiment of the present invention where a sheet member is supplied onto the base 180, FIG. 6b is a front cross-sectional view of the punching device in accordance with an embodiment of the present invention where the base 180 and the body 110 are aligned by a magnetic force, FIG. 6c is a front cross-sectional view when the user pushes the button member 160 downwardly, FIGS. 6d and 6e are plan views of the sheet member punched by the punching device in accordance with an embodiment of the present invention, and FIG. 7 is a plan view showing a state when the punching device of FIG. 6c is utilized.

Hereinafter, an operation of the punching device 100 in accordance with a preferred embodiment of the present invention as constructed above will be described with reference to FIGS. 6a to 6e and 7.

First of all, a user supplies a sheet member S onto a support member 283 on which a star shaped guide hole is formed. At this time, the sheet member S can be positioned at a desired accurate position with reference to horizontal and vertical guide lines 295 and 296 formed on the support member 283 (see FIG. 6a).

Thereafter, the body 110 including the jig 130 on which the star shape of pattern hole 130a is taken to be closed to the support member 283. When the body 110 is closed to the support member 283 on which the sheet member S is supplied, the body 110 is rotated at a certain angle by magnetic forces of the two pairs of the respective three magnets (the first magnets 121, 122 and 123, and the second magnets 191, 192 and 193) inserted into the jig 130 and the support member 183, so that the star patterns formed on the jig 130 and the support member 183 are aligned to the same line (see FIG. 6b).

Finally, after aligning the star patterns formed on the jig 130 and the support member 283, when the user manually pushes the button member 160 downwardly (see FIG. 6c), the punching member 150 is gone down to cause the punching pin 151 to pass through the jig 130 and the support member 283 to cut a corresponding area of the sheet member S, thereby punching the star pattern SI at a desired position of the sheet member S (see FIG. 6d).

In addition, after fixing the sheet member S using the center pin 282, when the punching operation is repeatedly performed while rotating the sheet member S at a certain angle, the star pattern S2 can be repeatedly punched at desired positions at predetermined intervals (see FIG. 6e).

As set forth above, the punching device in accordance with the present invention has diverse advantages as follows.

Firstly, it is possible to simply and accurately align the pattern on the same line using such a constitution that includes a body and a base, which are fully separated from each other and have a plurality of magnets, namely, by attraction and repulsion of the plurality magnets inserted into a jig and a guide plate, on which a pattern hole and a guide hole are formed in the same shape, respectively.

Namely, since magnetic forces are equally acted by interaction of the magnets as above within a certain distance with a sheet member disposed between the body and the base, it is possible to simply and accurately align the pattern on the same line even when the sheet member is supplied onto the base and thus the user cannot visually recognize a position of the guide hole formed at the support member.

Therefore, it is possible to readily punch a desired pattern at all positions required by a user, including a center portion as well as a periphery portion of a sheet member, differently from the prior art that punching is allowed on only specific portions of the supplied sheet member.

In addition, it is possible to allow children to more stably use the punching device by extending a button member and a housing, that is, by forming a body more lengthily, to function as a handle.

Further, a jig, a punching member, and a support member are formed of a zinc material, thereby providing superior cutting and coating properties.

Furthermore, a plane portion of the punching member is contacted with the jig as close as possible using a spiral spring as a resilient member; and thus, an amount of zinc consuming can be decreased by minimizing a length of a zinc punching pin and also productivity of the punching device can be improved by alleviating a weight of the punching device itself.

It is also possible to prevent a sheet member from being crumpled by supporting the sheet member using a base during punching by means of making a size of the base larger than that of a body.

And also, it is possible to help supply a sheet member to an accurate position, at which the user wants to punch, by forming horizontal and vertical guide lines on a surface of the support member.

Moreover, it is possible to repeatedly punch a desired pattern at a position spaced apart by a certain distance from a center at predetermined intervals while rotating a sheet member, and also prevent movement of the sheet member during a punching operation of the user, by installing a center pin at a predetermined position of a surface of the support member.

While the present invention has been shown and described with respect to particular embodiments, it will be apparent to those skilled in the art that many changes and modifications may be made without departing from the spirit and scope of the invention as defined in the appended claims.

What is claimed is:

1. A punching device comprising a body and a base separated from the body for accurately forming a desired pattern at a position required by a user, the body comprising:
a jig on which a predetermined shape of pattern hole is formed;
a punching member having a punching pin provided with a cutting blade corresponding to the predetermined shape of the pattern hole, and for punching a desired position of a sheet member while moving up and down with respect to the jig; and
a resilient member interposed between the punching member and the jig for recovering the punching member,
wherein at least two magnets are inserted into the jig.

2. The punching device according to claim 1, wherein the base comprises:
a guide plate on which the same shape of guide hole as the pattern hole of the jig is formed; and
a support member for fixing the guide plate and providing a supply surface to which the sheet member to be punched is supplied,
wherein at least two magnets are inserted into the guide plate.

3. The punching device according to claim 2, wherein the magnets inserted into the jig and the magnets inserted into the guide plate are arranged in such a way that S and N poles are appropriately combined on the basis of the pattern hole and the guide hole.

4. The punching device according to claim 3, wherein the magnets are arranged in such a manner that the three magnets are disposed at intervals of 120°.

5. The punching device according to claim 1, wherein the resilient member is a spiral spring.

6. The punching device according to claim 2, wherein each of the punching member, the jig, and the guide plate is formed of a zinc material.

7. The punching device according to claim 1, wherein the body further comprises:
a button member, as a contact portion, disposed on the punching member to be pushed by a user's hand; and
a housing enclosing the button member, the punching member, and the resilient member.

8. The punching device according to claim 1, wherein the base is configured to be larger than the body.

9. The punching device according to claim 1, wherein the base is provided with horizontal and vertical guide lines formed on a surface of a support member.

10. The punching device according to claim 1, wherein the base further comprises a center pin.
